(19) United States
(12) Patent Application Publication
(10) Pub. No.: US 2015/0361868 A1
(43) Pub. Date: Dec. 17, 2015

(54) THERMAL MANAGEMENT OF ENGINE CHARGE AIR

(71) Applicant: International Engine Intellectual Property Company, LLC, Lisle, IL (US)

(72) Inventors: Budhadeb Mahakul, Napeville, IL (US); Shouhao Wu, Roselle, IL (US)

(21) Appl. No.: 14/306,480

(22) Filed: Jun. 17, 2014

(51) Int. Cl. F02B 29/04; F02M 31/04

(52) U.S. Cl. CPC F02B 29/0493; F02M 31/04

(57) ABSTRACT

An engine manages charge air temperature by heating charge air as the engine warms toward normal operating temperature.

### TECHNICAL FIELD

This disclosure relates to internal combustion engines, such as those which commonly propel motor vehicles.

### BACKGROUND

A liquid-cooled internal combustion engine which propels a motor vehicle typically comprises a temperature-controlled valve, an example of which is commonly referred to as an engine thermostat, for controlling flow of engine coolant to a radiator. The thermostat comprises an inlet to which coolant, which has been pumped through a system of coolant passageways in an engine cylinder block and engine cylinder head by a coolant pump, is communicated. The thermostat has two outlets, one to the radiator, the other to a coolant return passage which leads to the suction side of the coolant pump.

When the engine begins running from cold-start, the coolant pump pumps coolant through the system of coolant passageways in the engine cylinder block and cylinder head to the thermostat inlet while the thermostat closes the one outlet to the radiator and opens the other outlet to the coolant return passage. That prevents heat from being wasted by rejection to air passing through the radiator until the engine reaches normal operating temperature range. Once the engine has warmed to normal operating temperature, the thermostat opens the one outlet to the radiator and closes the other outlet to the coolant return passage to maintain coolant temperature within a normal engine operating temperature range.

A turbocharged internal combustion engine typically has a heat exchanger at which heat of compression created in air compressed by a turbocharger compressor is rejected. That heat exchanger is commonly called a charge air cooler. Cooling charge air increases charge air density thereby increasing mass air flow into engine cylinders so that for a given air-fuel ratio an increased quantity of fuel can be injected. Some engines may have a by-pass for shunting some charge air around a charge air cooler.

Proper performance of certain engine exhaust after-treatment systems involves exhaust temperature management. For example, when temperature in a system is less than about 200° C., dosing of fuel and/or diesel exhaust fluid is generally ineffective for NOx conversion. Prior thermal management techniques include exhaust back pressure control via a valve and/or a variable geometry turbocharger, intake throttling, and combustion timing retard.

### SUMMARY OF THE DISCLOSURE

The present disclosure relates to an engine which provides more efficient after-treatment during certain engine operating conditions, such as during the early part of transient test cycles, during engine warm up, and during transients under light engine load, by providing closer control of temperature of charge air entering the engine and more rapid rise in that temperature as the engine warms toward normal operating temperature range.

A general aspect of the present disclosure relates to an internal combustion engine which comprises: an intake system comprising a supercharging device operable to draw air into the intake system and create superatmospheric pressure in an intake manifold; engine structure comprising engine cylinders within which combustion of fuel occurs to generate heat which is transferred to liquid coolant flow through internal coolant passageways in the engine structure; and an engine cooling system comprising a coolant pump for circulating liquid coolant through the internal coolant passageways and a coolant control valve operable to direct coolant from the internal coolant passageways, as a function of engine operating temperature, selectively through a radiator at which heat is rejected to airflow through the radiator and through a by-pass around the radiator.

The intake system further comprises a charge air cooler, a charge air heater, and at least one charge air control valve operable to direct charge air from the supercharging device, as a function of engine operating temperature, selectively through the charge air cooler and through the charge air heater.

Another aspect relates to the thermal management method which is inherent in aforementioned general aspect.

The foregoing aspects, and additional ones, will be presented in the Detailed Description below with reference to the following drawings that are part of this disclosure, and also in the Claims.

### BRIEF DESCRIPTION OF THE DRAWINGS

FIG. 1 is a schematic diagram of a first embodiment illustrating a first mode of operation.

FIG. 2 is a schematic diagram of the first embodiment illustrating a second mode of operation.

FIG. 3 is a schematic diagram of a second embodiment illustrating a first mode of operation.

FIG. 4 is a schematic diagram of the second embodiment illustrating a second mode of operation.

### DETAILED DESCRIPTION

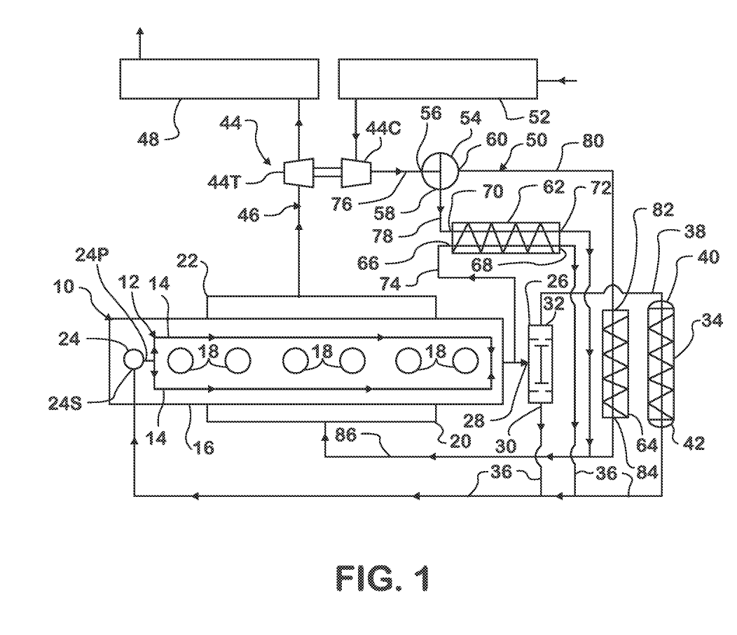

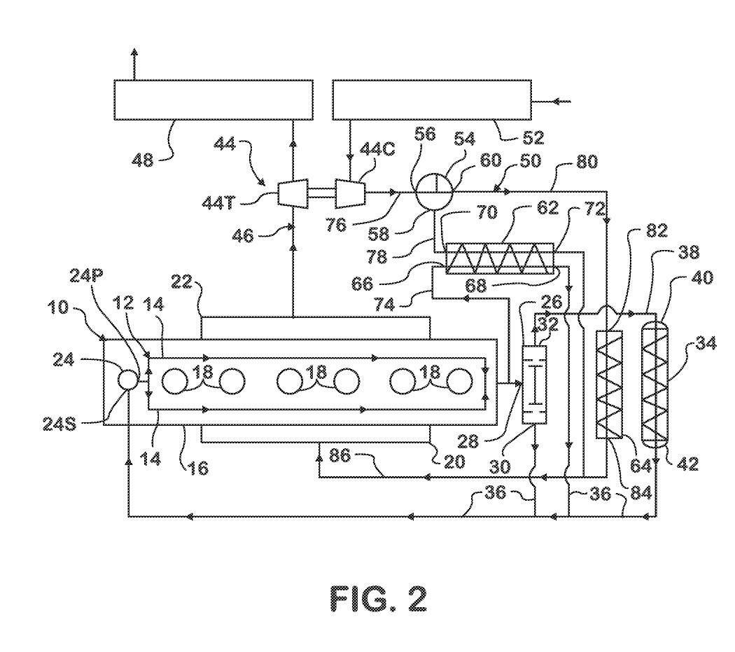

FIGS. 1 and 2 show an internal combustion engine 10 for propelling a motor vehicle such as a large truck. Engine 10 is shown by way of example as an in-line six-cylinder turbocharged diesel engine.

Engine 10 comprises a liquid cooling system (LCS) 12 having various flow paths through which liquid coolant circulates, including a system of internal coolant passageways 14 in engine structure 16 which contains engine cylinders 18 within which combustion of fuel occurs to operate engine 10. Engine structure 16 typically comprises an engine cylinder block overlying an engine crankcase, and depending on the particular cylinder block configuration, one or more cylinder heads, intake manifolds, and exhaust manifolds. Engine 10 has a single intake manifold 20 and a single exhaust manifold 22.

Liquid coolant is circulated through LCS 12 by a coolant pump 24, which comprises a suction inlet port 24S and a pressure outlet port 24P. As coolant pump 24 operates, it pumps coolant through pressure outlet port 24P into and through internal coolant passageways 14 where the circulating coolant absorbs heat created by combustion of fuel in engine cylinders 18. Coolant pump 24 may be driven by engine 10 or other suitable means.

LCS 12 further comprises a coolant control valve 26 having an inlet 28, a first outlet 30, and a second outlet 32. Coolant which has passed through internal coolant passageways 14 is communicated to inlet 28, and flow entering through inlet 28 is selectively controlled to first outlet 30 and to second outlet 32 by coolant control valve 26.

LCS 12 further comprises a radiator 34 at which heat is transferred from coolant flowing through coolant tubes of radiator 34 to air flowing though radiator 34.

First outlet 30 is communicated through a return flow passage 36 to suction inlet port 24S.

Second outlet 32 is communicated through a flow passage 38 to an inlet header 40 of radiator 34. Radiator 34 has an outlet header 42 which is communicated through return flow passage 36 to suction inlet port 24S.

When engine coolant temperature is less than a defined normal engine operating temperature range, coolant control valve 26 closes inlet 28 to second outlet 32 while opening inlet 28 to first outlet 30 as shown in FIG. 1. That prevents coolant leaving internal coolant passageways 14 from flowing through radiator 34 by diverting the coolant flow entering coolant control valve 26 back to suction inlet port 24S through return flow passage 36. By causing coolant to by-pass radiator 34 so that heat is not rejected to radiator 34 after engine 10 has been cold-started and is warming toward normal operating temperature range, engine 10 is able to reach normal engine operating temperature range more quickly than if coolant were instead allowed to pass through radiator 34.

In engine technology, normal engine operating temperature range is understood as a range which is reached after a cold engine has been fully warmed and within which the engine continues to operate until shut down.

As engine coolant temperature approaches normal engine operating temperature range, coolant control valve 26 starts to open second outlet 32 and to close first outlet 30, fully opening the former and fully closing the later when normal operating temperature range is reached as in FIG. 2. That enables heat in coolant passing through radiator 34 to be rejected to air passing through radiator 34 with heat transfer occurring by ram air effect and/or by a fan or fans (not shown) pulling or pushing air through radiator 34. Rejection of engine heat to air passing through radiator 34 maintains engine operation in normal engine operating temperature range.

Coolant control valve 26 is typically referred to by the generic descriptor “engine thermostat.” Various types of engine thermostats are known. In subsequent description, coolant control valve 26 may sometimes be referred to as thermostat 26.

Engine 10 comprises a supercharger an example of which is a turbocharger 44 having a turbine 44T and a compressor 44C. Turbine 44T is operated by engine exhaust which flows from exhaust manifold 22 through an exhaust system 46. Engine exhaust passes through turbine 44T and then through an exhaust after-treatment system 48 before being discharged to atmosphere.

Compressor 44C is operated by turbine 44T to develop a charge air flow by drawing intake air into an intake system 50 through an air intake 52 and compressing it to create superatmospheric pressure in intake manifold 20.

Intake system 50 comprises a charge air control valve 54 having an inlet 56, a first outlet 58, and a second outlet 60. Intake system 50 further comprises a first heat exchanger 62 and a second heat exchanger 64. Second heat exchanger 64 is commonly referred to as a charge air cooler because its primary function is to remove some of the heat of compression created in the air compressed by compressor 44C when engine 10 is running in normal operating temperature range. In subsequent description second heat exchanger 64 may sometimes be referred to as charge air cooler 64.

First heat exchanger 62 functions as a heater for heating charge air and comprises a coolant inlet 66, a coolant outlet 68, an air inlet 70, and an air outlet 72. In subsequent description first heat exchanger 62 may sometimes be referred to as heater 62 or charge air heater 62. A coolant flow path extends between coolant inlet 66 and coolant outlet 68. A flow path for charge air extends between air inlet 70 and air outlet 72. First heat exchanger 62 is shown by way of example as a parallel flow type, but could be a different type, such as a counter-flow type.

Charge air heater 62 is connected into LCS 12. Coolant which has passed through internal coolant passageways 14 flows through a passage 74 to coolant inlet 66, through charge air heater 62 to coolant outlet 68, and from there through return passage 36 back to suction inlet port 24S.

Inlet 56 of charge air control valve 54 is communicated through a charge air passage 76 to compressor 44C. A charge air passage 78 communicates first outlet 58 of charge air control valve 54 to air inlet 70 of heater 62. A charge air passage 80 communicates second outlet 60 of charge air control valve 54 to an inlet 82 of charge air cooler 64. An outlet 84 of charge air cooler 64 communicates with intake manifold 20 through a charge air passage 86. Air outlet 72 of heater 62 also communicates with intake manifold 20 through charge air passage 86. This arrangement places charge air control valve 54 upstream of both charge air heater 62 and charge air cooler 64 in intake system 50.

FIG. 1 illustrates use of first heat exchanger 62 to heat the supercharged air developed by turbocharger 44 as the air passes from compressor 44C to intake manifold 20 before temperature of engine 10 reaches normal operating temperature range. When engine 10 is cold-started, radiator 34, charge air heater 62 and charge air cooler 64 are cold. Thermostat 26 blocks flow of coolant through radiator 34, as mentioned above. If charge air were allowed to pass through charge air cooler 64, it would lose heat as it does so because the charge air cooler acts as a heat sink. Hence charge air control valve 54 directs charge air flow through charge air heater 62 and not through charge air cooler 64.

Although it is initially cold, charge air heater 62 is being gradually heated by coolant which is shunted around thermostat 26 through charge air heater 62 while none of the coolant flow coming from internal coolant passageways 14 is allowed to flow through radiator 34. As charge air heater 62 is being heated, it begins to transfer heat to charge air being directed through it by charge air control valve 54.

Once engine 10 reaches normal operating temperature range, charge air control valve 54, operating as a two-position directional control valve, ceases to direct charge air flow through charge air heater 62 and instead directs charge air flow through charge air cooler 64, as shown in FIG. 2. Although thermostat 26 now is also directing flow of coolant from internal coolant passageways 14 through, instead of by-passing, radiator 34, some coolant flow from passageways 14 continues to be shunted through charge air heater 62. The connection of charge air heater 62 into LCS 12 provides uninterrupted coolant flow from internal coolant passageways 14 through the coolant flow path in charge air heater 62 regardless of engine operating temperature.

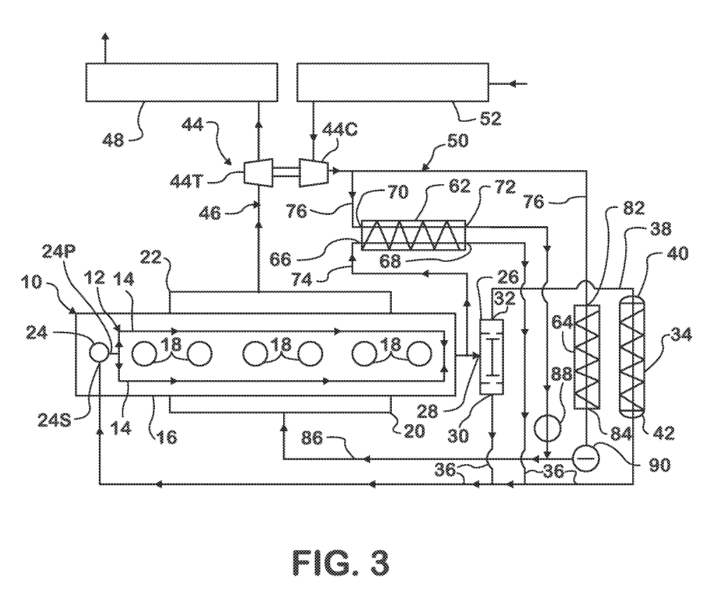

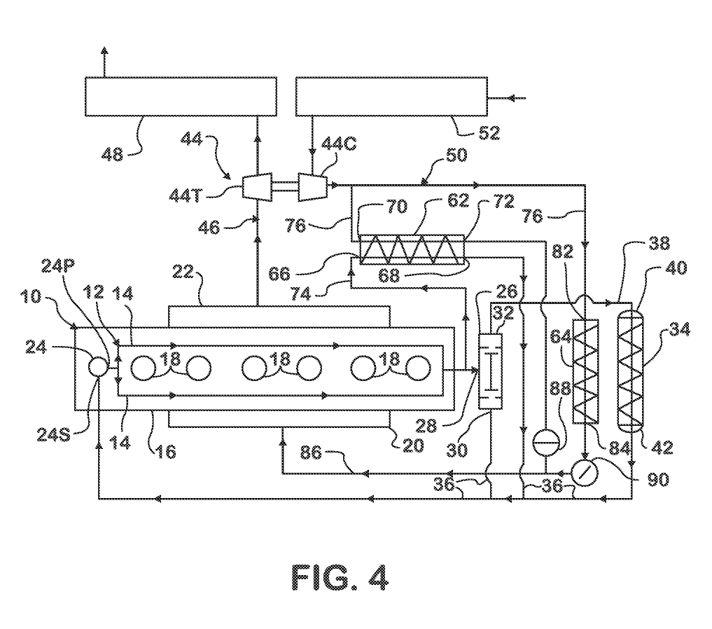

FIGS. 3 and 4 show a second embodiment which differs from the first embodiment in certain respects. However, reference numerals appearing in FIGS. 1 and 2 identify the same elements shown in FIGS. 3 and 4.

The second embodiment differs from the first in that charge air control valve 54 is replaced by separate first and second charge air control valves 88, 90 for controlling charge air flow. Air inlet 70 of charge air heater 62 and inlet 82 of charge air cooler 64 are both communicated directly to compressor 44C through charge air passage 76. Air outlet 72 of charge air heater 62 communicates with charge air passage 86 through first charge air control valve 88. Outlet 84 of charge air cooler 64 communicates with charge air passage 86 through second charge air control valve 90. This arrangement places first charge air control valve 88 downstream of charge air heater 62 and second charge air control valve 90 downstream of charge air cooler 64 in intake system 50.

FIG. 3 illustrates use of heater 62 to heat the supercharged air developed by turbocharger 44 as the air passes from compressor 44C to intake manifold 20 before temperature of engine 10 reaches normal operating temperature range. First charge air control valve 88 is open, allowing charge air to flow from compressor 44C through heater 62 to intake manifold 20. Second charge air control valve 90 is closed, preventing charge air flow from compressor 44C through charge air cooler 64.

Once engine 10 reaches normal operating temperature range, first charge air control valve 88 closes, preventing charge air flow from compressor 44C through heater 62 to intake manifold 20, and second charge air control valve 90 opens, allowing charge air flow from compressor 44C through charge air cooler 64.

Various control strategies may be employed in accomplishing the general control strategy and method which have been described above. They may include factors which are additional to temperature, and they may include variations on how valves are operated.

What is claimed is:

1. An internal combustion engine which comprises:
an intake system comprising a supercharging device operable to draw air into the intake system and create superatmospheric pressure in an intake manifold;
engine structure comprising engine cylinders within which combustion of fuel occurs to generate heat which is transferred to liquid coolant flow through internal coolant passageways in the engine structure;
an engine cooling system comprising a coolant pump for circulating liquid coolant through the internal coolant passageways and a coolant control valve operable to direct coolant from the internal coolant passageways, as a function of engine operating temperature, selectively through a radiator at which heat is rejected to airflow through the radiator and through a by-pass around the radiator;
the intake system further comprising a charge air cooler, a charge air heater, and at least one charge air control valve operable to direct charge air from the supercharging device, as a function of engine operating temperature, selectively through the charge air cooler and through the charge air heater.

2. The internal combustion engine as set forth in claim 1 in which the at least one charge air control valve is operable to cause charge air to flow through the charge air cooler, and not through the charge air heater, when engine operating temperature is within a normal engine operating temperature range which is reached after a cold engine has been fully warmed, and to cause charge air to flow through the charge air heater, and not through the charge air cooler, when engine operating temperature is less than the normal engine operating temperature range.

3. The internal combustion engine as set forth in claim 2 in which the coolant control valve is operable to direct coolant from the internal coolant passageways through the radiator, and not through the by-pass around the radiator, when engine operating temperature is within the normal engine operating temperature range, and to direct coolant from the internal coolant passageways through the by-pass around the radiator, and not through the radiator, when engine operating temperature is less than the normal engine operating temperature range.

4. The internal combustion engine as set forth in claim 3 in which the at least one charge air control valve is disposed in the intake system upstream of both the charge air cooler and the charge air heater.

5. The internal combustion engine as set forth in claim 4 in which the at least one charge air control valve comprises a two-position directional control valve having an inlet for charge air from the supercharging device, a first outlet to the charge air heater, and a second outlet to the charge air cooler.

6. The internal combustion engine as set forth in claim 3 in which the at least one charge air control valve comprises a first charge air control valve operable to selectively allow and prevent flow of charge air through the charge air heater and a second charge air control valve operable to selectively allow and prevent flow of charge air through the charge air cooler.

7. The internal combustion engine as set forth in claim 6 in which the first charge air control valve is disposed in the intake system downstream of the charge air heater and the second charge air control valve is disposed in the intake system downstream of the charge air cooler.

8. The internal combustion engine as set forth in claim 2 in which the charge air heater comprises a heat exchanger having a coolant flow path connected into the engine cooling system for coolant flow from the internal coolant passageways and a charge air flow path for charge air flow from the supercharging device, the heat exchanger providing for coolant flow through the coolant flow path in the heat exchanger to heat charge flow through the charge air flow path in the heat exchanger.

9. The internal combustion engine as set forth in claim 8 in which connection of the heat exchanger into the engine cooling system provides uninterrupted coolant flow from the internal coolant passageways through the coolant flow path through the heat exchanger regardless of engine operating temperature.

10. The internal combustion engine as set forth in claim 1 in which the supercharging device comprises a compressor of a turbocharger.
